(19) United States
(12) Patent Application Publication
(10) Pub. No.: US 2007/0275160 A1
(43) Pub. Date: Nov. 29, 2007

(54) Carbon Nanostructure-Based Electrocatalytic Electrodes

(76) Inventors: Stephen Maldonado, Austin, TX (US); Keith J. Stevenson, Austin, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 10/575,737

(22) PCT Filed: Oct. 12, 2004
(86) PCT No.: PCT/US04/33602

§ 371 Date: May 30, 2007

Related U.S. Application Data
(60) Provisional application No. 60/510,707, filed on Oct. 10, 2003.

(51) Int. Cl. C25B 11/00; C09D 1/00; C25B 1/00

(52) U.S. Cl. 427/122; 106/286.8; 205/334; 977/742; 977/939

(57) ABSTRACT

CNF electrodes disclosed herein may be conveniently prepared on conductive substrates by pyrolysis of iron(II) phthalocyanine in a reducing atmosphere. Such electrodes may possess suitable properties for preparation of electrocatalytic electrodes and electrochemical sensors. High surface area nitrogen doped CNFs prepared according to certain embodiments are conductive and may exhibit high stability and improved catalytic activity for O₂ reduction in aqueous solutions.

### BACKGROUND OF THE INVENTION

1. Field of Invention

The present invention relates generally to methods for preparing carbon nanostructures (e.g., carbon nanofibers). Certain embodiments relate to carbon nanostructures that may be used in electrodes for electroanalytical sensors or electrochemically-based technologies such as batteries or fuels cells.

2. Description of Related Art

The literature for carbon-based electrodes is rich in studies with traditional forms of carbon (i.e., carbon blacks, pyrolytic graphite and glassy carbon). However, much less attention has been given to carbon nanofiber (CNFs) and carbon nanotube (CNTs) materials as electrocatalysts. CNFs and CNTs are largely classified together as a single type of carbon material. The term “carbon nanotube” has been used as the main descriptor for various forms of tubular carbon of recent study. As used herein, a “CNT” refers to a carbon structure small enough to exhibit observable quantum effects (e.g., less than about 30 nm). As used herein, a “CNF” refers to a carbon structure too large to exhibit observable quantum effects (e.g., greater than about 30 nm). As used herein, “carbon nanostructures” includes carbon nanofibers (CNFs) and carbon nanotubes (CNTs).

Certain carbon materials may possess properties desirable for design of electrodes used for electrochemical devices. However, electrochemical oxidation and reduction of a variety of technologically-relevant analytes (e.g., oxygen, hydrogen peroxide, methanol) may exhibit slow electron transfer kinetics with carbon electrodes.

### SUMMARY

Methods of preparing carbon nanostructures, and films and electrodes including carbon nanostructures, are disclosed herein. In an embodiment, carbon nanostructures may be formed directly on a conductive substrate (e.g., nickel). In some embodiments, the carbon nanostructures may be carbon nanofibers. In other embodiments, the carbon nanostructures may be carbon nanotubes. Carbon nanostructures prepared by methods disclosed herein may exhibit certain electrochemical properties that may be desirable. Carbon nanostructures may exhibit relatively high stability, conductivity, high surface area and chemical resistance.

In an embodiment, carbon nanostructures may be formed on a conductive substrate by heating an organometallic nanostructure precursor in the presence of the conductive substrate. Heating of the nanostructure organometallic precursor in the presence of the conductive substrate may be performed at a temperature that is at or above a temperature at which the organometallic nanostructure precursor undergoes pyrolysis. In certain embodiments, an organometallic nanostructure precursor may be a metal phthalocyanine or metal porphyrin. The metal of the metal phthalocyanine and metal porphyrins may be a transitional metal. In another embodiment, an organometallic nanostructure precursor may be a metallocene. Metallocenes may include a transitional metal coupled to a cyclopentadienyl ring. Transitional metals that may be used include, but are not limited to, iron, nickel, platinum, molybdenum, titanium and ruthenium. Other metals that may be used include alkaline and alkaline earth metals (e.g., magnesium). Organometallics may be used as catalytic modifiers for carbon-based electrodes. Organometallics may lower a kinetic overpotential for oxygen reduction. Early studies demonstrated that annealing of various metal macrocycles on carbon black increases their catalytic behavior but that at temperatures much beyond 650° C. their catalytic behavior is severely diminished. Additionally, some metal tetraphenylporphyrin-loaded carbon black electrodes, subjected to even higher heat stresses (>850° C.) to cause pyrolysis of the organometallic precursor, have been reported to have catalytic performances close to that of commercial platinum particles. Pyrolyzed metal phthalocyanines on a carbon surface may not exhibit as great a catalytic behavior as low temperature annealed metal phthalocyanines, but their stability over repeated use may be much better than low temperature annealed electrodes.

In an embodiment, an electrode may include a carbon nanostructure film that includes carbon nanostructures that have been grown directly on the surface of a conductive substrate. The carbon nanostructures may be grown by pyrolyzing an organometallic nanostructure precursor. In one embodiment, the carbon nanostructures may be doped with nitrogen.

In an embodiment, an oxygen containing compound may be decomposed by contacting a carbon nanostructure electrode with an aqueous solution containing the oxygen containing compound. In some embodiments, an electrode including carbon nanostructures may be used in an electroanalytical sensor. In other embodiments, an electrode including carbon nanostructures may be used in fuel cells or batteries. In certain embodiments, an electrode may be preconditioned by contacting the electrode with a salt solution and cycling a potential applied to the electrode to increase the wettability of the electrode.

### BRIEF DESCRIPTION OF THE DRAWINGS

Advantages of the present invention will become apparent to those skilled in the art with the benefit of the following detailed description of embodiment and upon reference to the accompanying drawings, in which:

FIG. 1 depicts x-ray photoelectron spectra for C1s and N1s core levels of CNF electrodes;

FIG. 2 depicts a voltammetric response of a CNF electrode immersed in a deaerated aqueous solution of 0.1 M KNO₃;

FIG. 3 depicts voltammetric response of a CNF electrode (solid line) and a bare nickel mesh electrode (dotted line) immersed in an aqueous solution containing 0.5 M KNO₃ after deaeration with Ar;

FIG. 4 depicts voltammetric response of a CNF electrode immersed in an aqueous solution containing 0.5 M KNO₃ after O₂ saturation;

FIG. 5 depicts a chronocoulometric response plot of Q vs t^{1/2} (Anson plot) measured for solutions containing 1 M KNO₃ and indicated amounts of dissolved O₂;

FIGS. 6 and 7 depict a chronocoulometric response plot of Anson slope vs. dissolved O₂ concentration obtained over different concentration ranges;

FIG. 8 depicts linear sweep voltammograms of a CNF electrode immersed in aqueous solutions of pH: 5.5, 7.7, 9.0, 10.6, and 12.6;

FIG. 9 depicts a plot of the apparent charge transfer coefficient, α′obs, versus pH; and

FIG. 10 depicts a voltammetric response of a CNF electrode immersed in an O₂ saturated aqueous solution containing 1 M NaOH.

FIG. 11 depicts a comparison of measurements taken in gasometric experiments with suspensions of bulk samples of N-doped CNF and non-doped CNF.

While the invention is susceptible to various modifications and alternative forms, specific embodiments thereof are shown by way of example in the drawings and will herein be described in detail. It should be understood that the drawing and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS

While several methods such as arc and laser deposition have been used for producing carbon nanotubes (CNT) and carbon nanofibers (CNF), chemical vapor deposition (CVD) methods may be more facile for large scale production of well defined carbon-based films and arrays. In an embodiment, a method of forming carbon nanostructures may be based on the bulk pyrolysis of metal phthalocyanines. (A discussion of such methods may be found in Huang, S.; Dai, L.; Mau, A. W. H.; J. Phys. Chem. B., 1999, 103, 4223.) Examples of synthesis methods may produce CNFs and CNTs that are substantially aligned perpendicular to the supporting substrate. Several investigators have conducted electrochemical investigations of SWCNTs, MWCNTs and CNFs electrodes made by spin coating suspensions onto conductive substrates. Others have relied upon gross transfer of a carbon film from a growth substrate onto a conductive surface. In the former case, the films formed by such spin coating methods typically include disordered mats of dense, randomly entangled nanotubes. In the latter case, the effects of physical transfer and/or chemical treatments on the carbon nanostructures may be poorly understood and/or recognized. Carbon nanostructure materials grown directly on conductive substrates may avoid these complications.

Embodiments presented herein include methods for direct preparation of substantially vertically-aligned carbon nanostructure (e.g., carbon nanofiber) electrodes produced directly on a metallic substrate. Such embodiments may be performed without excessive pre-treatment, post-treatment or chemical surface activation. A difference between carbon nanostructures that are grown directly on a conductive substrate and carbon nanostructures formed by physically transferring the nanostructures to a conductive substrate may be that carbon nanostructures directly grown on conductive substrates may not include a binding agent. An additional difference may be that where the nanostructures are to be used in electrodes, the carbon electrocatalyst properties of the nanostructures (e.g., orientation, alignment, crystalline, composition) may be tuned by adjustment of the pyrolysis protocol. Additionally, formation of electrodes by direct growth on a conductive substrate may provide an inherently easier, quicker, and/or more controllable method than traditional methods for malting high surface area carbon electrodes. Preliminary studies of carbon nanostructure electrodes prepared using iron(II) phthalocyanine demonstrate high electrocatalytic ability for the reduction of dissolved oxygen at neutral to basic pHs. The repeatability and stability of such carbon electrodes may be excellent, as signified by the electrodes' linear response to changes in dissolved oxygen

In some embodiments, a carbon nanostructure electrode may include atomically dispersed elements. An carbon nanostructure electrode may include variety of elements or compounds, including, but not limited to, carbon, nitrogen, iron, nickel, platinum, molybdenum, titanium, ruthenium, manganese, sulfur and alloys, oxides or mixtures thereof.

In some embodiments, carbon nanostructures may be doped with non-carbon atoms (heteroatoms). For example, a carbon nanostructure may be doped with nitrogen atoms. In certain embodiments, carbon nanostructures may form a film that is catalytically active to solution or gas phase species.

In an embodiment, three-dimensional conduits of carbon nanofiber ensembles may be produced from carbon nanostructures grown on a substrate. After growing a carbon nanofibers on a substrate, the substrate and carbon nanofibers may be soaked in an acid such as concentrated HNO₃ or aqua regia. In some embodiments, the acid may dissolve a portion of the conductive substrate. A film of carbon nanofibers may be separated from the substrate. Experiments were conducted to form carbon nanostructures on a conductive substrate. Carbon nanostructures formed directly on a conductive substrate were then tested to assess the properties of the nanostructures as electrodes.

In one embodiment, to grow the carbon nanostructures, nickel mesh (commercially available as Alfa Aesar, 100 mesh) was cut into 0.40 cm² squares prior to pyrolysis. The pyrolysis of iron(II) phthalocyanine (commercially available from Aldrich, and hereafter denoted as “FePc”) on nickel mesh substrates was performed at 990° C. in a reducing atmosphere of Ar—H₂ (99.997 and 99.95%, respectively, commercially available from Praxair). A gas flow reactor was used. The gas flow reactor included a quartz tube and a two zone reactor tube furnace. The quartz tube had an outer diameter about 35 mm and an inner diameter about 32. The two zone tube furnace (commercially available from Thermcraft, model 2158-6-3ZH) was fitted with temperature controllers. Prior to growing the carbon nanostrucutres, the nickel mesh substrates were inserted into zone 2 of the furnace. The quartz tube was purged with Ar for ˜10 minutes. Subsequently, a mixture of Ar and H₂ gases (at about a 0.8:1 ratio) was introduced to the furnace. The gas flow was about 47 ccm (cubic centimeter per minute). During the gas purge, the two furnace zones were heated to designated temperatures. Specifically, zone 1 was heated to about 500° C. and zone 2 was heated to about 1000° C. When the cooler (upstream) zone 1 reached 500° C., 0.2 g of FePc was introduced and nanostructure growth was allowed to occur for about 5 minutes. The temperature of zone 1 was then raised up to about 1000° C. and maintained at this temperature for about 15 minutes. The furnace was then turned off and the carbon nanofiber (CNF) electrodes were allowed to cool in the furnace until the temperature reached about 850° C. The hydrogen gas flow was stopped while Ar flow was increased to 45 ccm to maintain an approximately constant total gas flow. The entire furnace was allowed to cool to room temperature under the Ar gas flow. The CNF electrodes were then removed from the quartz tube and stored in sealed gas tight vials pending structural and electrochemical characterization.

The carbon films of the CNP electrodes appeared on the nickel mesh substrate as a fine black felt-like or carpet-like layer. The nominal mass of carbon film prepared in this manner was about 1 mg. The carbon films adhered relatively strongly to the nickel. Scanning electron microscopy (SEM) of the resultant carbon nanotube films was carried out on a LEO 1530 operating at 10 kV. Transmission electron microscopy (TEM) was performed on a JEOL 2010F operating at 120 kV. TEM samples were prepared by first suspending collected nanotubes in ethanol and then placing a drop of the suspension on copper grid (200 mesh, PELCO) with a thin carbon coating. Surface analysis of the CNF was performed by X-ray photoelectron spectroscopy (XPS) using a PHI 5700 ESCA system equipped with Al K-alpha monochromatic (1486.6 eV) photons. Photoelectron spectra were recorded for the C1s, N1s, O1s, Fe2p_{1/2} and Fe2p_{3/2} core levels. All spectra are referenced to low, medium, and high photoelectron energy ranges using Au4f_{7/2}, Ag3d_{5/2} and Cu2p_{3/2} at 83.98, 368.27, and 932.67 eV, respectively.

A single glass compartment, three electrode, gas tight electrochemical cell was employed for cyclic voltammetry and chronocoulometry studies of the electrodes. Pt mesh (commercially available from Aldrich) and Hg/Hg₂SO₄ (saturated K₂SO₄, available from CH Instruments) were used as counter and reference electrodes, respectively. Carbon nanofiber/nickel mesh or glassy carbon served as the working electrode. Glassy carbon electrodes (diameter=5 mm, Alfa Aesar) were fabricated by casting in resin (Epon 828, Resolution Performance Products) and polished with 1, 0.3, and 0.05 micron diameter alumina slurries prior to use. Geometric surface areas of the carbon nanofiber electrodes were determined by chronocoulometry (CC) using hexaamineruthenium(III) chloride (Strem Chemicals) in 1 M KNO₃. Bare nickel electrodes were stepped from −0.4V to −0.8V vs. Hg/Hg₂SO₄ (saturated K₂SO₄) for 1 second and the area was calculated from the slope (m=2nFAD₀^{1/2}Cp^{-1/2}) of the linear portion of the Q vs. t^{1/2} plot (Anson plot) using the diffusion coefficient, D₀=7.3×10⁻⁷ cm² s, determined by the steady state current (iₗᵢₘ=4nFD₀Cr) of a platinum microelectrode with r=13 μm. For three bare nickel mesh electrodes, the observed electroactive area was 1.1±0.1 cm². Because the diffusion layer thickness for all measurements was sufficiently large ((Dt)^{1/2}=16 μm for the shortest experimental time, υ=100 mV/s), the diffusion layer was assumed to follow the overall exposed nanofiber area rather than individual tubes. The geometric surface area of the CNF electrodes was taken to be the same area of the equivalent bare nickel mesh electrodes.

Solutions in absence or presence of O₂ were prepared by purging with either Ar or O₂ (99.5%, Praxair) introduced through a gas inlet of the electrochemical cell. Pressures and concentration of O₂ were measured using a mercury manometer connected to the cell. Dissolved oxygen concentrations were calculated using the Bunsen coefficient (i.e., Henry's Law constant) for oxygen solubility in 1 M KNO₃ at 25° C., as discussed in MacArthur, C. G.; J. Phys. Chem., 1916, 20, 495. The diffusivity of dissolved oxygen, assumed to be 1.75×10⁻⁵ cm s⁻¹, (see Xu, J.; Huang, W.; McCreery, R. L.; J. Electroanal. Chem., 1996, 410, 235) is used in calculations involving chronocoulometry (Anson slopes). The solution was stirred while the cell was being pressurized and prior to and after each electrochemical experiment.

For cyclic voltammetry and chronoamperometry studies, the aforementioned gases were bubbled through the test solutions for 20 minutes prior to the start of measurements (to fully purge and to fully oxygenate, respectively) and again for 1 minute in between measurements. Solution volumes were ˜5-10 ml. The cell was kept at ambient pressure. Electrolyte solutions were prepared using potassium nitrate (EM Science, 99.9%), sodium hydroxide (Aldrich, 99.99%), and/or boric acid (Spectrum, 99.9%) as received. The solutions with pH values 5.1 to 10.6 had formal concentrations of 0.9 M KNO₃ and 0.1 M HBO₃. The pH was adjusted by adding small aliquots of concentrated NaOH. The solution with a pH of 12.6 was made with 1 M KNO₃ and a small amount of NaOH added. The solution with a pH of 14 was 1 M NaOH.

Chronoamperometry studies were performed using a single potential-step method. The method stepped from an initial potential of −0.3 V to a final potential of −0.7 V potential. The charge passed for a period of one second was recorded. Cyclic voltammograms (CV) in the presence of oxygen were obtained by sweeping the potential from −0.2V to −0.9V at various sweep rates between 5 mV/s and 100 mV/s in corresponding supporting electrolytes presence of oxygen. All CVs conducted in the presence of oxygen were background subtracted. All electrode potentials are reported vs Hg/Hg₂SO₄ (saturated K₂SO₄) which is ca. 0.64 V positive of NHE. All electrochemical measurements were taken with a quiescent solution. The electrochemical cell temperature was held at a constant temperature (23±0.5° C.) by placing in water bath. All electrochemical studies were performed with either a CH Instruments 700A potentiostat or an Autolab PGSTAT 30 interfaced to a PC.

In general, CNFs are produced via catalytic dehydrogenation of hydrocarbons (e.g., acetylene, xylene) over metallic catalyst nanoparticles (e.g., Fe, Ni, Co) dispersed on insulating substrates (e.g., SiO₂ and alumina). In embodiments presented herein, organometallic precursors such as metallocenes and phthalocyanines (e.g., iron(II) phthalocyanine) act as both the hydrocarbon source and decomposition catalyst to yield aligned nanofiber bundles. (A discussion of organometallic precursors may be found in Rao, C. N. R.; Govindaraj, A. Acc. Chem. Res. 2002, 35, 998.) Using a modified synthesis scheme this approach may be adapted to prepare aligned CNF electrodes directly on conducting nickel mesh substrates. Scanning electron microscopy (SEM) studies of CNPs prepared in this way, showed the homogenous distribution of nanofibers on the nickel surface with no discernable bare spots or uncoated regions observed. The produced material includes carpet- or felt-like structures of carbon fibers that were fairly uniform and aligned normal to the nickel substrate. Fiber lengths were generally greater than 10 μm and diameters ranging from about 40-60 nm. Higher magnification TEM images revealed the presence of hollow fibrils exhibiting irregular and interlinked corrugated features, consistent with other reports describing the preparation of nitrogen-doped nanotubes. Straight segments of parallel aligned graphene sheets of the CNF appear crystalline and ordered over 10's of nm distances. These more crystalline domains intersect with more disordered regions and give rise to compartmentalized bamboo-like structures. These graphitic dislocations in the nanofiber correspond to sites where edge plane graphitic carbon is exposed at the sidewalls. TEM images also showed the occurrence of iron nanoparticles which appeared to be encapsulated with graphic shells or within the CNF.

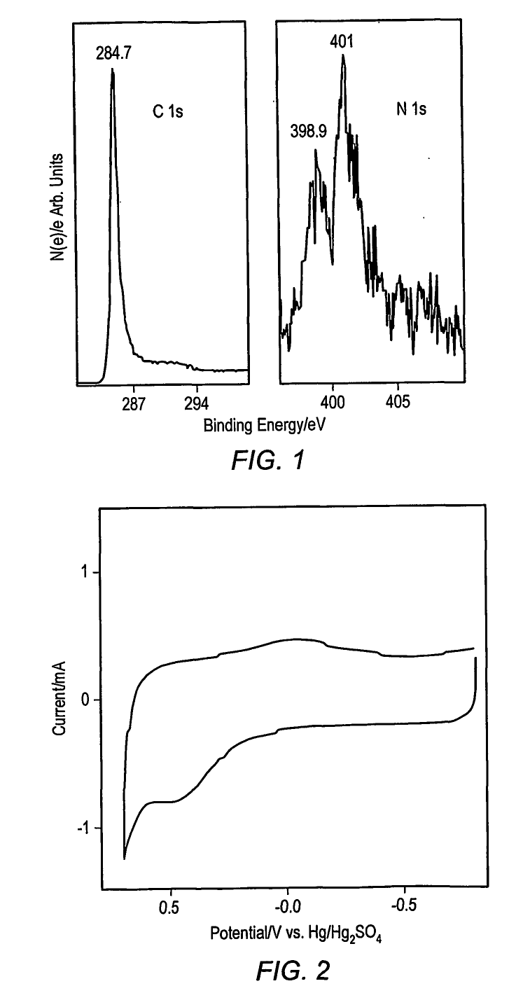

XPS analysis of the CNF electrodes (as depicted in FIG. 1) indicates that the carbon is predominantly sp² hybridized as evidenced by the presence of a Cis binding energy of 284.7 eV, similar to that of HOPG (as discussed in Poirier, D. M.; Weaver, J. H.; Surf. Sci. Spectra, 1994, 2(3), 232). No detectable sidebands in the C1s region (285-291 eV) were evident to denote the presence of graphene oxides or oxygen containing functionalities on the CNF electrodes. A small O1s signal at 532.6 eV appeared to indicate the existence of physisorbed oxygen. Additionally, the presence of a Nis doublet at ˜398.9 and 401.0 eV was consistent with the incorporation of nitrogen within the graphene sheets. In agreement with similar reports for CNTs grown by pyrolysis of other metal (cobalt and nickel) phthalocyanines, the binding energy centered at 398.9 eV corresponds to “pyridinic” nitrogen while that at 401.0 eV is commensurate with “pyrrolic” type nitrogen. The former refers to N atoms, which contribute to the π system with one p electron, while the latter refers to N atoms with two p electrons on the π system, although not necessarily coordinated in a five membered ring as pyrrole. A very weak peak at ˜405 eV also exists that is consistent with presence of “graphitic” nitrogen, corresponding to highly coordinated N atoms substituting inner carbon atoms in the graphene sheets. A very weak doublet of peaks at 707 and 720 eV corresponding to the Fe2p_{3/2} and Fe2p_{1/2} signals was evident suggesting the presence of reduced iron species. No binding energy peaks within the range 700-740 eV were apparent to denote the existence of oxidized forms of iron (Fe²⁺ or Fe³⁺). Integration of the relative N and Fe elemental abundances indicated that CNFs contain roughly 1% (mass) nitrogen and 0.5% (mass) iron. Surface concentrations were mainly carbon with ˜1% N atoms and ˜0.1% Fe atoms.

Catalytic grown CNFs are known to be strongly hydrophobic as prepared. Typically, in order for these materials to be used in electrochemical applications involving aqueous electrolytes, the carbon electrode needs to be preconditioned or pretreated so that they are easily wettable when immersed in electrolyte. Harsh chemical or electrochemical oxidation methods that use concentrated nitric and sulfuric acids are typically employed to effectively introduce oxygen containing surface functionalities (carboxy and carboxylic anhydride groups). However, this abrasive treatment may lead to breakdown or fracture of the CNF nanostructure. CNF electrodes prepared according to embodiments disclosed herein also do not easily wet. However, in an embodiment, mild electrochemical conditioning of such electrodes by cycling from −1.4 to +0.8 V vs Hg/HgSO₄ at 100 mV/sec in aqueous 1M KNO₃ for a period of about two minutes induces uniform wetting of the CNF electrodes. This is evidenced by a large increase in the voltammetric current during cycling when the entire carbon film fully saturates with electrolyte.

A typical voltammetric response for CNF electrodes immersed in deaerated solution containing 0.1 M KNO₃ is shown in FIG. 2 for potential cycles between +0.8 and −0.8 V vs Hg/HgSO₄. Over most of the potential range, only capacitive charging currents are observed. A small anodic peak observed at +0.8 V is characteristic of nitrate insertion into the CNFs, broadly consistent with previous reports for voltammetric investigations of HOPG electrodes in similar electrolytes. A broad cathodic wave is also seen in this potential range corresponding to the deintercalation of nitrate ions, indicating that the insertion process may be reversible. The CNF electrodes are very stable as no changes in the voltammetric response is observed for extended cycling between +0.8 and −0.8 V. Typically anion intercalation may be accompanied by formation of graphine oxide, however, the appearance of no new voltammetric peaks to signify the formation of oxygen functionalities are observed after extended potential cycling. The mild conditioning step described in embodiments herein should not be confused with more rigorous electrochemical pretreatment activation (ECP) methods reported by McCreery and others. ECP of HOPG electrodes in potassium nitrate solutions has been reported previously, but the conditions used in embodiments presented herein are much milder. For example, the CNF electrodes were cycled to much less extreme oxidation potentials, and much shorter time periods (cf. +0.8 V vs +2.2 V vs Hg/HgSO₄). The electrochemical activation step employed was enough to overcome the strong hydrophobicity of the carbon films but was not enough to introduce oxygen surface functionalities or to damage the CNF structure. XPS and SEM analysis of wetted electrodes showed no changes in the overall CNF composition or structure. TEM analysis was inconclusive in determining if possible structural changes or defects were introduced after the wetting step. Regardless, from the available evidence, there appears to be no substantial amount of oxygen functionalities inherent to or introduced to the CNF electrodes during electrochemical conditioning.

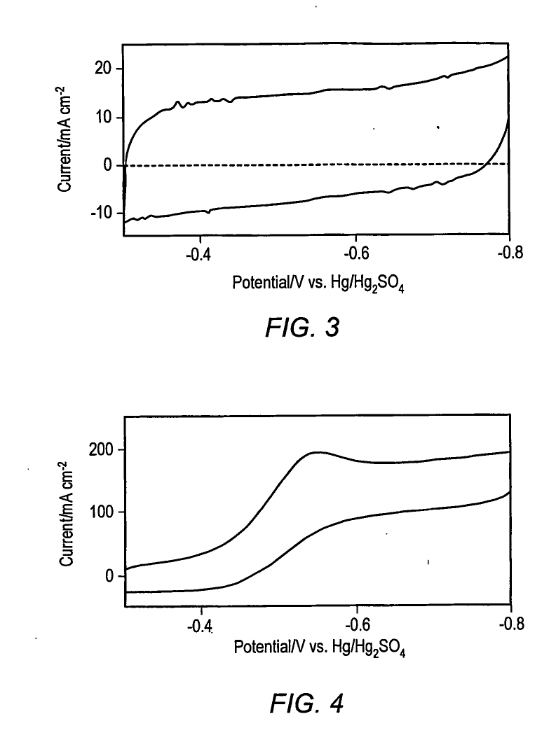

FIGS. 3 and 4 show representative CVs of CNF electrodes immersed in a 0.5 M KNO₃ solution for potential cycles between −0.4 and −0.8 V in the absence of oxygen (FIG. 3) and presence of oxygen (FIG. 4). In the absence of oxygen, the voltammetric response exhibits only a capacitive response. It also can be seen that the current measured for a CNF coated nickel electrode is several orders of magnitude higher than that for the uncoated nickel electrode of the same area in oxygenated or deaerated solutions, indicating that the observed electrochemical response is inherent to the CNFs and not the underlying substrate. The CNF are expected to exhibit larger background current signals than the bare nickel because the higher surface area leads to a higher overall capacitance. From FIG. 3, the capacitance of the films can be estimated to be roughly 11 F/g in potassium nitrate. The estimated capacitance is in agreement with the wide range of reported specific capacitance values ranging been 4 to 80 F/g and 18 to 40 F/g for electrolyte conditions similar to this study. FIG. 4 shows that when the carbon nanofiber films were cycled at a scan rate of 5mV/s in aqueous solutions saturated with O₂, a peak for the reduction of oxygen was observed near −0.5 V vs Hg/Hg₂SO₄.

Potential step experiments were conducted to demonstrate that the carbon nanotube electrodes were sensitive to the oxygen content in solution. To best discern the faradaic response from the large capacitive charging of the electrodes, chronocoulometry was used. With chronoamperometry or cyclic voltammetry, the measured signal is a combination of the faradaic and capacitive currents., Distinguishing the two components may be difficult for electrodes with a large capacitance. Chronocoulometry allows the effects from the two processes to be readily discerned. It has been shown that after an initial time for the electrode surface to charge, a plot of the total charge passed vs. t^{1/2}(Anson plot) is linear and a result of the faradaic process.
Q=2nFAD₀^{1/2}π^{-1/2}t^{1/2} (1)

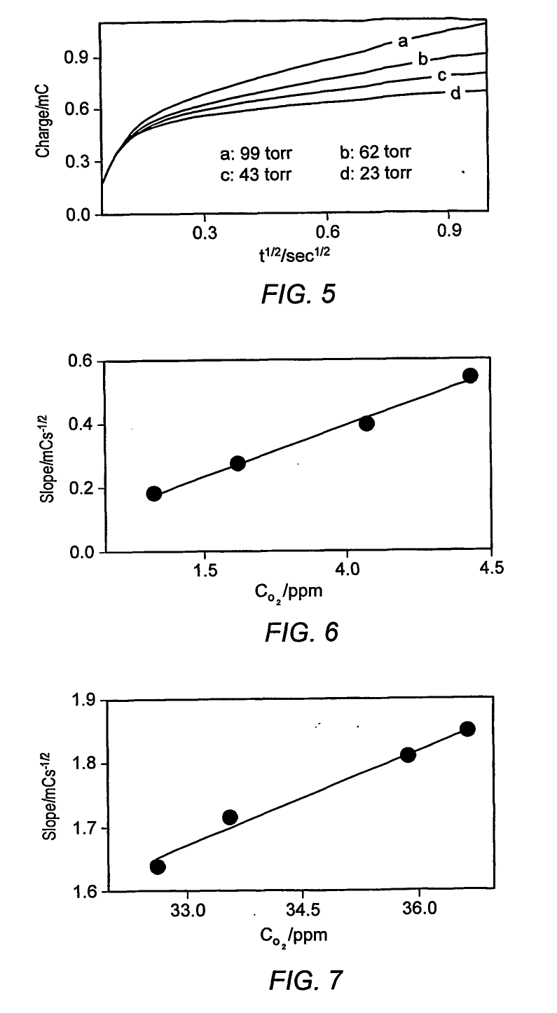

The slope of the linear portion is then directly proportional to the concentration of dissolved oxygen and is independent of the material capacitance, as shown FIG. 5. As previously described, the concentration of dissolved oxygen can be estimated from the partial pressure of oxygen above the solution by way of Henry's Law. Controlling the oxygen partial pressure in the cell allowed for chronocoulometric measurements in the ppm oxygen concentration ranges. FIGS. 6 and 7 show that the change in Anson plot slopes over the studied concentration ranges was linear. The number of electrons for the observed responses was 2.3, consistent with a 2e⁻ reduction to peroxide species.

For neutral to alkaline pH values, oxygen is irreversibly reduced to hydrogen peroxide on unmodified carbon surfaces.
O₂+H₂O+2e⁻→HO₂⁻+OH⁻ (2)

E⁰=−0.065V (vs. NHE) For a given scan rate, E_{p/2}, (potential where the current is half the peak current) is more or less fixed but at more alkaline environments E_{p/2} shifts more negative. For an irreversible 1e⁻ reduction or an overall ne⁻ reduction pathway with a 1e⁻ irreversible reduction as the rate determining step, the difference between the peak potential, Eₚ, and E_{p/2} is given by:

$${E}_{p / 2} - {E}_{p} ≡ \frac{1.857 RT}{{α}_{obs} F} \qquad ( 3 )$$

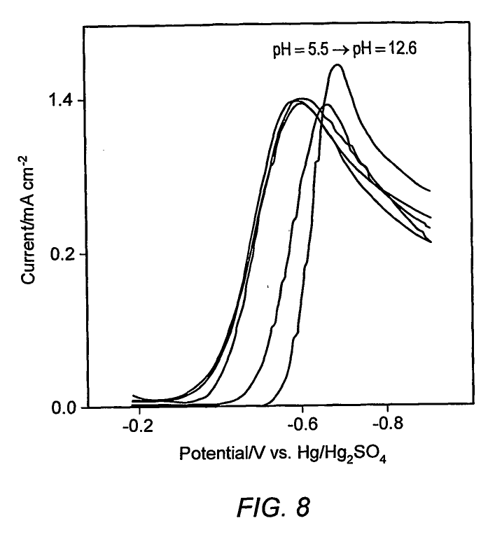

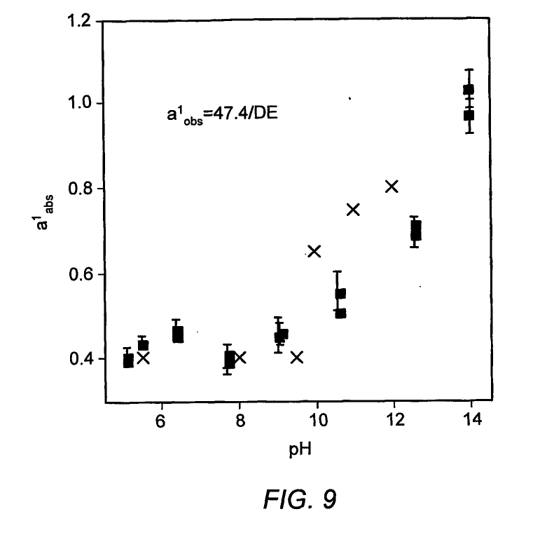

While the direct application of this equation to the reduction of oxygen on most carbon surfaces is inappropriate, it does serve as a reminder that the peak width of the obtained voltammograms should change if the observable transfer coefficient α_{obs}) changes (e.g., the kinetics of the reduction change.) FIG. 8 also shows that the peak width of the reduction wave is broad and roughly constant in slightly acidic to neutral pH solutions but sharpens significantly in increasingly more alkaline environments. The peak widths for a set of scans for a given pH solution may be used to roughly gauge α_{obs} by using Equation 1, as seen in FIG. 9. (In FIG. 9, square symbols with error bars represent experimental data. Crossed symbols represent data from the literature for a similar experiment using borate buffer.) A similar trend was noted with glassy carbon surfaces that had undergone various pretreatments. α_{obs} may increase with increased alkalinity on glassy carbon surfaces with a large number of adsorption sites. The availability of a large number of adsorption sites may allow the reduction of dioxygen to superoxide to become the rate-determining step in strongly alkaline environments.
O₂+e⁻→O₂⁻_{(ads)} (4)

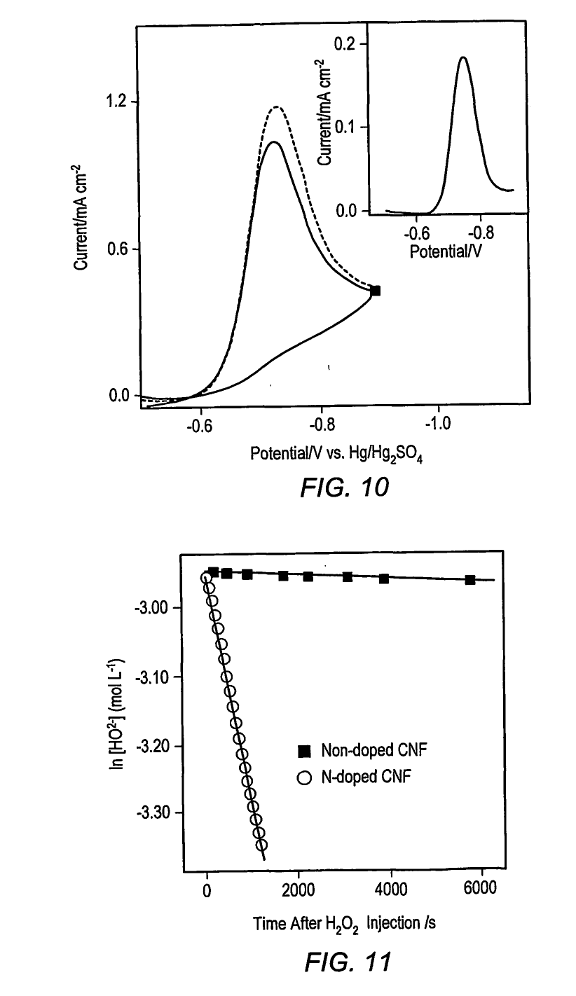

Although the exact nature of adsorption sites is not understood, it is clear that high defect carbon surfaces show a greater activity for oxygen reduction. It has been noted that in aqueous solutions the observed current densities for oxygen reduction on the basal plane of stress annealed pyrolytic graphite is lower than on glassy carbon or ordinary pyrolytic graphite. It has been demonstrated that HOPG surfaces with greater specific capacitances required a lower overpotential for the oxygen reduction wave, with the understanding that the larger the number of defects (e.g., exposed edge plane graphitic planes) on an HOPG surface, the larger the specific capacitance. If adsorption sites are related to edge plane graphite planes, then a surface with a large amount of exposed edge plane graphite should exhibit considerable oxygen reduction activity. Such kinks are evident in the TEM images of nanotubes described herein. Each dislocation is a site of exposed edge plane graphite. Adsorption of oxygen on the carbon nanofibers disclosed herein was evident in the first voltammogram obtained after bubbling oxygen gas through the test solution for 20 minutes. FIG. 10 shows that the first voltammogram was noticeably larger than the following scans at the same scan rate. (In FIG. 10, the dashed voltammogram was initially recorded following a 20-minute oxygenation step. The solid voltammogram was obtained after an additional 1 minute of oxygenation. The inset reflects subtraction of the first (dashed) voltammogram from the second (solid) voltammogram.) The presumed reason for the larger initial observed current is adsorption of oxygen onto the carbon surface. Subtraction of a second scan voltammogram from the first scan voltammogram showed a symmetric gaussian peak, the ‘extra’ adsorbed oxygen. No attempt was made to quantify the amount of adsorbed oxygen as it seemed to be dependent on solution conditions and allotted time of oxygenation. The timescale for the oxygen adsorption was thought to be slow, as the one minute interval between successive scans was not enough to show a larger current. Therefore, it is consistent that carbon nanotubes with a large density of kinks per unit length should show considerable activity for oxygen reduction. There has been at least one report in the literature noting possible electrocatalytic properties of some unspecified type of MWCNTs for the reduction of oxygen, but the condition of the electrode (mixture of carbon nanotubes with liquid paraffin) and the ill-defined voltammetry makes it difficult to ascertain the electrocatalytic effect, if any, of that carbon nanotube material. Another observed feature of the voltammograms in this report is that the peak potential shifted slightly at neutral pH but shifted more negative with increased alkalinity. This is in contrast to the behavior of conventionally polished glassy carbon electrodes. Conventionally polished glassy carbon electrodes have been shown to exhibit a complex dependence on solution pH involving the transition of two distinct reduction waves, attributed to the reduction of oxygen with and without adsorption of superoxide species. The generalized behavior of glassy carbon is that the voltammograms become sharper in peak width and occur at a more positive potential in alkaline solutions. It is interesting to note that in very alkaline solutions (pH>10), the reduction wave of the carbon nanotubes disclosed herein occurred at nearly the same potential of conventionally polished glassy carbon.

Comparisons of the CNF electrodes to earlier reports of transition metal macrocycle modified carbon electrodes, which have been studied extensively for catalytic behavior in fuel cell applications, may be appropriate because both systems represent large surface area carbon electrodes. FePc was adsorbed onto Vulcan XC-72 carbon in a study that showed that the adsorbed organometallic complex shifted the reduction wave well positive (˜0.5V) of the reported values for most unmodified carbon surfaces. The catalytic behavior was attributed to the ability of the iron centers to coordinate with dissolved dioxygen. It was a concern in the present study that residual FePc was present, despite the fact that the growth temperature used was well above the temperature where the molecule is known to completely breakdown, particularly the iron-nitrogen bonds. Capacitive voltammograms in Ar purged solution in 1 M NaOH showed neither of the reversible waves described in the literature for the Fe^{3+/2+} couple or the Fe^{2+/0} couple of bulk iron(II) phthalocyanine on XC-72 carbon. Therefore, it is believed that the observed electrochemical response is not due to residual FePc.

At least two other factors should be considered when comparing CNF electrodes to other carbon materials. There is considerable nitrogen content in these carbon nanotubes and there are still iron nanoparticles present within the tube walls. Nitrogen incorporation in graphene sheets is thought to dramatically affect the catalytic ability of graphitic carbon in electron transfer reactions. The electron transfer kinetics of the CNF electrodes were also examined using of two well known redox couples. Five different electrodes were studied and, scan rates for each electrode were recorded at 25, 50, 75, and 100 mV/s. For pooled electrodes, peak splittings for Ru(NH₃)₆^{3+/2+}, were 57±6 mV while for Fe(CN)₆^{3-/4-} were 55±2 mV, indicative of nearly ideal nernstian conditions and rapid charge transfer kinetics. In contrast, for MWCNT electrodes prepared by Meyappan et al., measured peak splittings ranging from 100-168 mV for Fe(CN)₆^{3-/4-} in 1 M KCl were observed to be a strong function of scan rate. Marken et al. reported similar peak splittings values of 168 mV for Ru(NH₃)₆^{3+/2+} for MWCNT electrodes. Using microelectrode fashioned from a small bundle MWCNTs, Ayajan measured ˜59 mV peak splittings for Fe(CN)₆^{3-/4-} in unspecified electrolyte. In general, only ideal behavior is observed for carbon based electrodes after significant electrode pretreatment or activation. Fast electron transfer kinetics of embodiments disclosed herein (inferred from the nearly ideal nernstian response) suggest that the electron-conducting properties of CNF may be enhanced when doped with N as a result of additional lone pairs of electrons that act as donors with respect to the delocalized π system of the hexagonal graphene network. This may well attribute to the low oxygen reduction overpotential necessary in neutral pH solutions and the increased necessary overpotential in alkaline environments. The nitrogen should play a role in determining the surface functionalities, particularly at higher pHs. Although the voltammetry does not indicate a significant amount of redox active surface groups, any surface groups present may play a strong role in electrocatalyic behaviors. In experiments discussed herein, the iron/nitrogen content in the nanofiber electrodes was not optimized; rather, it was kept constant for the samples considered. TEM analysis showed that the iron nanoparticles still present in the nanofibers were predominantly encased in graphite sheets. The background voltammograms exhibited no faradaic signals that could be attributed to iron oxidation.

In an embodiment, an N-doped CNF electrode may be used to decompose an oxygen containing compound (e.g., hydrogen peroxide, alkyl peroxides). In some embodiments, the oxygen reduction reaction can be treated as a catalytic regenerative process where hydrogen peroxide (HO₂⁻) is chemically decomposed to regenerate oxygen, 2HO₂⁻ [symbol] O₂+2OH⁻. The electrocatalysis mechanism described herein for dioxygen reduction is supported by the observed decomposition rate constants for hydrogen peroxide. In effort to assess this quantitatively, bulk measurements of the heterogeneous rate constant, kₕₑₜ, for the decomposition of hydrogen peroxide were carried out. Analyses were done in both 1 M KNO₃ and 1 M KOH using gasometric and rotating disk methods, respectively. FIG. 11 shows a comparison of separate gasometric experiments using 50 mL suspensions of 2 mg CNF bulk samples in 1 M KNO₃ after the injection of 50 mM H₂O₂. As shown in FIG. 11, N-doped CNF electrodes are catalytically active for the decomposition of hydrogen peroxide. Similar results were obtained with the rotating disk method. Measured and reported values for the heterogeneous hydrogen peroxide decomposition rate constant, kₕₑₜ are presented in Table 1.

TABLE 1

| | kₕₑₜ × 10⁵ (cm s⁻¹) | kₕₑₜ × 10⁵ (cm s⁻¹) |
|---|---|---|
| Catalyst | 1 M KOH | 1 M KNO₃ |
| Non-doped CNF | 0.01 ± 0.004 ^{a} | 0.0030 ± 0.0004 ^{b} |
| N-Doped CNF | 1.8 ± 0.5 ^{a} | 0.51 ± 0.07 ^{b} |
| LaFe_{0.1}Ni_{0.9}O₃ | −53.0 | — |
| Pt black | 28.9 | — |
| MnO₂ | 0.1 | — |

^{a}Values obtained from rotating disk measurements
^{b}Values obtained by gasometric analysis.

The measured difference in kₕₑₜ between the undoped and N-doped CNFs was found to vary over two orders of agnitude in both media. The almost unmeasurable kₕₑₜ for the undoped CNFs was in agreement with conventional, unactivated carbons. The large kₕₑₜ for N-doped CNFs was on the same order of magnitude of rigorously and methodically activated carbon blacks, as well as that observed for a more commonly used peroxide elimination catalyst, MnO₂. The decomposition rates measured for N-doped CNFs were within an order of magnitude of rates reported for platinum blacks. XPS studies showed surface iron concentrations at values lower than quantifiable limits, which may imply that most of the iron is encapsulated within the interior of the CNFs and inactive, as it is protected from the contacting solution. A possible explanation for the observed enhanced decomposition rate is that the defining catalytic active site involves surface nitrogen functionalities.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description to the invention. Changes may be made in the elements described herein without departing from the spirit and scope o the invention as described in the following claims. In addition, it is to be understood that features described herein independently may, in certain embodiments, be combined.

1. A method of forming a catalytic carbon nanostructure electrode, the method comprising:
heating an organometallic nanostructure precursor in the presence of a conductive substrate such that carbon nanostructures are grown directly on the surface of the conductive substrate by a vapor deposition process.

2. The method of claim 1, wherein the carbon nanostructures comprise carbon nanofibers doped with non-carbon atoms.

3. The method of claim 1, wherein the organometallic nanostructure precursor comprises nitrogen, wherein the carbon nanostructures comprise carbon nanonfibers doped with nitrogen atoms.

4. The method of claim 1, wherein the organometallic nanonstructure precursor comprises a metal phthalocyanine.

5. The method of claim 1, wherein the organometallic nanonstructure precursor comprises iron(II) phthalocyanine.

6. The method of claim 1, wherein the organometallic nanonstructure precursor comprises metal porphyrin.

7. The method of claim 1, wherein the organometallic nanonstructure precursor comprises a metallocene.

8. The method of claim 1, wherein heating the organometallic nanostructure precursor in the presence of the conductive substrate further comprises reacting the organometallic nanostructure precursor in an atmosphere comprising argon and hydrogen gases.

9. The method of claim 1, wherein heating of the organometallic nanostructure precursor is performed at or above a temperature at which the organometallic nanostructure precursor undergoes pyrolysis.

10. The method of claim 1, wherein the conductive substrate comprises nickel or platinum mesh.

11. The method of claim 1, wherein the carbon nanostructures comprise carbon nanotubes.

12. The method of claim 1, wherein the carbon nanostructures comprise carbon nanofibers.

13. The method of claim 1, wherein the carbon nanostructures are substantially perpendicular to the conductive substrate.

14. The method of claim 1, wherein heating the organometallic nanostructure precursor comprises selecting a pyrolysis protocol to tune at least one electrocatalyst property of the carbon nanostructures.

15. The method of claim 1, further comprising soaking at least a portion of the carbon nanostructures or the conductive substrate in an acid, and separating a carbon nanofiber film from the conductive substrate to produce three-dimensional conduits of carbon nanofiber ensembles.

16. The method of claim 1, wherein the carbon nanostructures comprise a doped carbon nanofiber film, wherein the doped carbon nanofiber film is catalytically active to solution or gas phase species.

17. A method for producing an electrode for an electrochemical device including a three dimensional catalytic ensemble of carbon nanofibers, comprising directly growing and dispersing carbonaceous materials and catalyst by vapor deposition of at least one organometallic compound.

18. A carbon nanostructure film, comprising:
a plurality of carbon nanostructures grown directly on a surface of a conductive substrate by heating an organometallic nanostructure precursor in the presence of the conductive surface.

19-34. (canceled)

35. The carbon nanostructure film of claim 18, wherein an overpotential necessary for the reduction of oxygen in aqueous solutions using the carbon nanostructure film is lower than on conventionally polished glassy carbon.

36. The carbon nanostructure film of claim 18, further comprising atomically dispersed nitrogen, iron, nickel, platinum, molybdenum, titanium, ruthenium, manganese, or sulfur, or alloys, oxides or mixtures thereof.

37. The carbon nanostructure film of claim 18, wherein the film is configured to be used as an electrode for catalytic reduction of oxygen.

38. A method of decomposing an oxygen containing compound, comprising:
contacting carbon nanostructures and/or a carbon nanostructure electrode with an aqueous solution comprising the oxygen containing compound.

39-49. (canceled)
